(19) United States
(12) Patent Application Publication
(10) Pub. No.: US 2008/0098675 A1
(43) Pub. Date: May 1, 2008

(54) FIRE-RESISTANT WINDOW

(76) Inventors: Klaus-Dieter Schwabe, Apolda (DE); Ruediger Freitag, Etterwinden (DE); Gerrit Panzner, Rudolstadt (DE); Jens Klossek, Weimar (DE); Markus Ring, Erfurt (DE); Klaus Schneider, Apolda (DE); Gerhard Lautenschlaeger, Jena (DE); Friedrich Siebers, Nierstein (DE)

Correspondence Address: Striker, Striker & Stenby, 103 East Neck Road, Huntington, NY, 11743, US

(21) Appl. No.: 11/876,380

(22) Filed: Oct. 22, 2007

(30) Foreign Application Priority Data
Oct. 25, 2006 (DE) 10 2006 050 113.6

(51) Int. Cl. E06B 3/263

(52) U.S. Cl. 52/204.5; 52/741.3

(57) ABSTRACT

The fire-resistant window of fire resistance class E according to DIN EN 357 has a window frame system (1, 6) and at least one thermally or chemically pre-stressed monolithic fire-resistant glass pane (2) mounted in the window frame system (1, 6). The at least one thermally or chemically pre-stressed monolithic fire-resistant glass pane (2) is made of a high-temperature-melting aluminosilicate glass with a softening point (log η=7.6) above 875° C., wherein η is the viscosity, and with a bending strength of over 100 N/mm². The glass pane (2) is also substantially impermeable to ultraviolet radiation.

### CROSS-REFERENCE

The invention disclosed and claimed herein below is also disclosed in German Patent Application 10 2006 050 113.6-45, filed Oct. 25, 2006, in Germany, which provides the basis for a claim of priority of invention under 35 U.S.C. 119 (a) to (d).

### BACKGROUND OF THE INVENTION

1. The Field of the Invention

The present invention relates to a fire-resistant window of the fire resistance class E according to DIN EN 357, which comprises at least one thermally or chemically pre-stressed monolithic fire-resistant glass pane in a suitable frame system.

2. The Related Art

In numerous fields of the construction industry, e.g. in residential, commercial, and industrial construction, the legal requirements for fire protection require fire-resistant barriers in public buildings, in motor vehicles, or in ships. Because of that the windows in doors and other buildings structures must meet the fire protection requirements of fire codes. Thus one speaks of fire-resistant or fire-protective windows.

Conventional window glass, i.e. soda lime glass, is unsuitable as a fire-protective barrier, because it explodes under strong heat load. Fire and the arising heat radiation would then spread unchecked. The reason for that is the comparatively high thermal expansion coefficient and comparatively small tensile strength of the soda lime glass.

Many fire-resistant windows, which resist fire for at least a predetermined time, were developed by industry. These fire-resistant windows are the subject of numerous relevant patent documents, which are based on the principle of achieving fire protection using special heat resistant transparent fire-resistant window panes, e.g. of glass ceramic or hardened glass, and predetermined arrangements and/or holders. The term “fire-resistant window” thus includes building elements and systems, which comprise one or more light-permeable glass panes and a frame system with holding and sealing elements for the glass panes.

All fire-resistant windows do not have the same fire resistance. This is determined in service or usage and is expressed by the so-called fire resistance class in the specifications of DIN EN 357. The fire resistance classes for windows are the EL, EW, and E class. They are additionally characterized by their fire-resistance duration in minutes, e.g. EL 30, EL 90, and E 30.

E windows only prevent the spread of fire and smoke for a certain time, i.e. they seal off the fire like a bulkhead. EW windows must additionally prevent the transmission of heat radiation. E and EW windows can be made with monolithic glass panes or also with multi-layer glass. The use of monolithic glass leads to a thinner and lighter structure.

In EL windows the glass surface temperature does not increase more than a certain amount on the side facing the fire. In order to achieve this combined systems of fire-resistant window panes and filler layers sandwiched between the fire-resistant window panes, which form foam in case of a fire, are customary for EL windows.

The use of pre-stressed soda lime glass or pre-stressed borosilicate glass to make monolithic fire-resistant windows is state of the art. Known pre-stressed soda lime glass has an E resistance time of 60 minutes. Known pre-stressed borosilicate glass has an E resistance time of 120 minutes.

However marketed E windows that are made from pre-stressed soda lime glass or borosilicate glass have considerable disadvantages in practice applications. While the selected frame systems (glass supporting systems) would permit a service life above 120 minutes, the fire-resistant window usually fails or breaks down as a system because of temperature-dependent glass distortion or deformation. The glass begins to flow on account of its own weight and the overpressure according to its dimensions and the temperature so that the E-related room sealing criterion room seal fails. Glass pane thickness above about 5 mm is thus necessary to achieve a service life of 60 minutes for great glass pane dimensions.

Of course glasses are available, which can handle a heavier or stronger heat load in comparison to soda lime glass, such as the borosilicate glass, e.g. according to EP 1 314 704 B1, and the special silicate glass panes, e.g. according to DE 197 10 289 C1. However these latter glasses do not satisfy all aspects of the actual architectural and fire-resistance technical requirements. The glasses of the above-cited German Patent documents have a comparatively low softening point of 750 to 830° C. The currently capable glass, i.e. the borosilicate glass, more over has a high UV permeability, which interferes with architectural design and technical considerations because of its high-energy permeability and radiation-dependent aging of building contents.

### SUMMARY OF THE INVENTION

It is an object of the present invention to provide fire-resistant windows, which do not have the above-described disadvantages.

It is an additional object of the present invention to provide fire-resistant windows of the E and the EW class comprising at least one pre-stressed monolithic glass pane (functioning window) in a suitable frame system, which has an increased resistance to heat loads, so that the window surface area of the fire-protective window can be substantially increased with the same or smaller glass thickness of the individual glass panes.

This object and others, which will be made more apparent herein after, are attained in a fire-resistant window of the fire resistance class E according to DIN EN 357, which comprises at least one thermally or chemically pre-stressed monolithic fire-resistant glass window pane in a suitable frame system.

According to one aspect of the present invention the fire-resistant glass pane comprises a high-temperature-melting aluminosilicate glass with a softening point above 875° C. such that glass viscosity η at the softening point is characterized by log η=7.6, with a bending strength of over 100 N/mm², and which is substantially UV-impermeable or UV-blocking.

Surprisingly it has been shown that the fire-resistant windows made from monolithic glass can be made without the above-mentioned disadvantages by the use of special high melting aluminosilicate glass. The fire-resistant windows according to the invention are highly transparent, i.e. they have a high optical quality. They have a very high resistance time in case of fire, which is considerably higher than the known fire-resistant windows, because of the high softening point of their glass composition. An increased resistance time of more than E 120 was established during a test according, to DIN EN 1363 (area/time). The minimum useable glass thickness is reduced to 2 mm. A high bending resistance and temperature-change resistance is attained by the strong chemical or thermal pre-stressing, which permits use of monolithic glass panes in the fire-resistant window. The bending strength amounts to at least 120 N/mm² for the thermally pre-stressed fire-resistant glass pane and at least 500 N/mm² for the chemically pre-stressed fire-resistant glass pane.

Usually the aluminosilicate glass used in the present invention is a largely UV-blocking or UV-impermeable glass.

The fire-resistant window according to the invention can have other glass panes besides the glass pane functioning as the fire-resistant glass pane, which are integrated in a laminated or insulating window with or without spacing from the fire-resistant glass pane.

The glass thickness of the functioning glass pane can be from 2 to 20 mm according to choice. In preferred embodiments it amounts from 3 to 12 mm.

Conventional high melting glasses are known in principle. Their use in fire-resistant windows was not possible up to now because of insufficient pre-stressing and the absence of the large-scale availability of these glasses with high optical quality.

In further preferred embodiments of the invention a coated glass pane that functions to provide fire-resistance and/or other coated window panes are used in fire-resistant windows. This coated glass pane can have one or more heat-blocking layers and is made of a so-called low-E glass to improve the radiation balance of the fire-resistant window in the infrared range. Also purely design-improving layers without additional function can also be provided. Heat-resistant glasses coated with silver, among others, are designated as low-E glass. Low-E means low emissivity, which is equivalent to low heat radiating (in comparison to a defined “black body”). They are also called heat-resistant glass or high blocking insulating glass.

Different frame systems can be used in the fire-resistant window according to the invention in connection with the monolithic glass pane made from high melting glass. Frames made from steel, aluminum, or wood elements, which can be combined as needed, are used in order to improve or adjust the properties.

Additional panes can be integrated into the fire-resistant windows besides the window pane that functions to provide the fire resistance or protection without difficulty. For example these fire-resistant windows can comprise laminates or can be embodied in a spatially separated arrangement (air intervening space) by means of an insulating glass structure with an opposing pane.

Additional embodiments of the present invention are set forth in the appended dependent claims and in the detail description appended herein below.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a front view of a window structure according to the present invention, which comprises a frame system and a fire-resistant glass pane mounted in the frame system;

FIG. 2 is a cutaway cross-sectional view of a first embodiment of a structural arrangement for receiving the fire-resistant glass pane in a profiled frame with a covering glass strip on both sides of the glass pane;

FIG. 3 is cutaway cross-sectional view of a second embodiment of a structural arrangement for receiving the fire-resistant glass pane in a profiled frame with a covering glass strip on one side of the glass pane;

FIG. 4 is a front view of another window structure according to the present invention, which is different from the window structure shown in FIG. 1 and comprises a frame system and a fire-resistant glass pane mounted in the frame system;

FIGS. 5A and 5B are cutaway cross-sectional views of different embodiments of an arrangement for mounting a fire-resistant glass pane in a steel frame section according to FIG. 4, and

FIG. 6 is a cutaway cross-sectional view of a corner region of a fire-resistant window with a fire-resistant glass pane according to the invention, which is constructed as an insulating window.

### DETAILED DESCRIPTION OF THE INVENTION

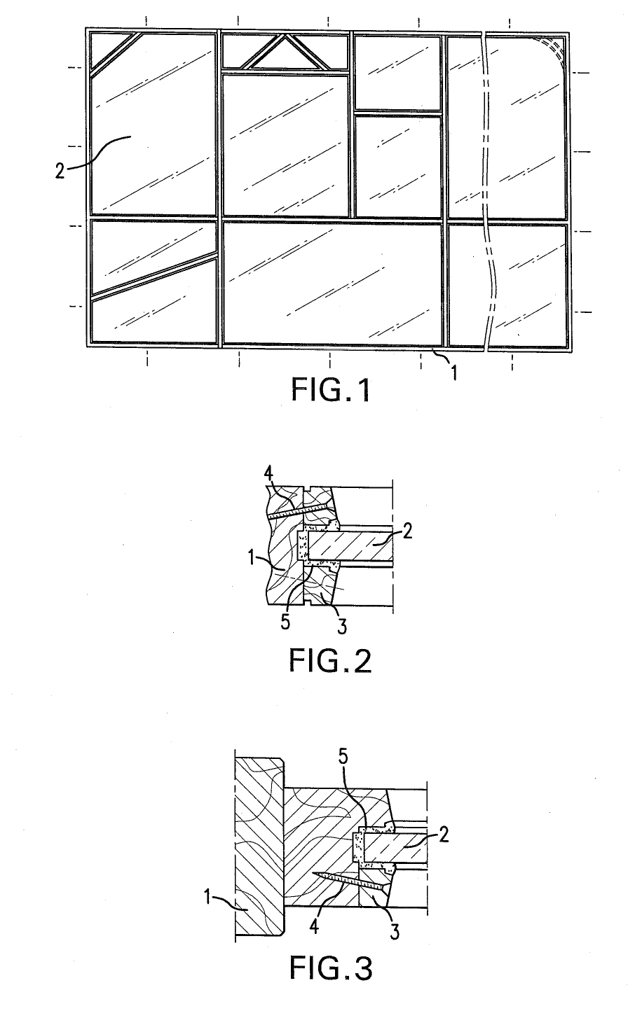

FIG. 1 shows a window structure comprising a wood frame system 1, which has a plurality of geometrically different frame areas. The geometric structure, which is shown in FIG. 1, is only one example of a window structure used for test purposes, in order to be able to test different shaped fire-resistant windows at the same time. The individual frame areas have different geometric shapes depending on their function to provide different spatial closures and/or desired designs.

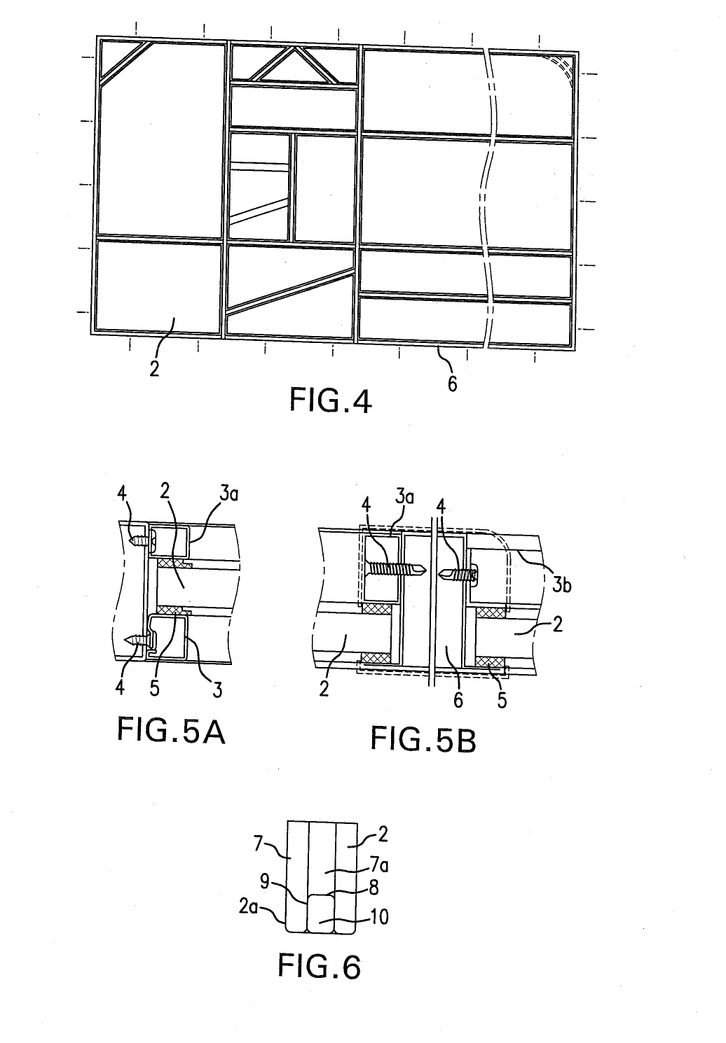

However generally the different frame areas have no special function. FIGS. 1 and 4 show the possible arrangements of the glass panes in the frame structure (e.g. maximum heights and widths) and special shapes (triangular, curved, etc), as they must usually be tested for granting a construction permit.

Typically the fire-resistant glass panes 2 (functioning panes) in these frame areas are made from glass with a softening point above 875° C., which is manufactured by the float process and thermally pre-stressed. They each have a thickness of 4 mm and a transmission for visible light in a range of from 90 to 92%.

The window structure comprises pure glass separating walls and also their combination with doors and windows in the scope of the present invention. A preferred embodiment is characterized by a glass door connected with a high window and side windows in a glass separating wall.

The wood structure can be constructed in any arbitrary manner with a stop section or with a glass molding or glass frame 3 that is nailed in, screwed in or glued in on both sides of the glass pane (FIGS. 2 and 3).

FIGS. 2 and 3 show how the fire-resistant glass pane 2 is mounted in the wood frame 1 with a screwed-in glass molding 3. In the embodiment shown in FIG. 2 a glass molding 3 is attached on both sides of the glass pane 2 with attaching screws 4. In the embodiment shown in FIG. 3 the glass molding 3 is screwed into the wood frame 1 on only one side of the glass pane. The glass pane 2 is mounted in the wood frame 1 with its edge in the groove or recess in the wood frame 1 and the edge of the glass pane is sealed in the groove with a silicone adhesive 5.

The dimensions of the largest glass pane in this window structure amounted to 1,600 mm×3,000 mm. The glass insertion depth amounted to 15 mm.

Fire testing according DIN EN 1363-1 took place with this window structure.

The service life of this structure amounted to more than 60 min, so that this fire-resistant window had a fire resistance class of E 60.

FIG. 4 shows a second embodiment of a window structure comprising steel frame 6. It has several frame areas with different geometric shapes like the first embodiment according to FIG. 1. What was said for the frame areas of the window structure of FIG. 1 can also be said of the frame areas of the window structure according to FIG. 4. Typically fire-resistant glass panes 2 (functioning panes) are installed in these frame areas, which are made from a glass with a softening point above 875° C. and a thickness of 8 mm, which is manufactured by the float process and chemically pre-stressed.

The total dimensions of the window structure in the case of FIG. 1 are 4000 mm×3000 mm. The largest glass pane measures 1,300 mm×2,500 mm. The glass insertion depth amounted to 15 mm.

The window structure shown in FIG. 4, like that of the first embodiment according to FIG. 1, can be embodied as pure glass separating walls or with glass walls combined with doors.

The steel frame 6 can be optionally constructed with a stop section or with a glass molding or glass frame that is clipped or screwed in on both sides of the glass pane, as shown in the embodiments of FIG. 5A or 5B. A hollow steel strip 3a or a steel angle bracket 3b can be used as the glass molding or glass frame.

Fire testing according DIN EN 1363-1 took place with these structures.

The service life of the window structure of FIGS. 5A and 5B amounted to more than 180 min, so that this fire-resistant window had a fire resistance glass of E 180.

In a third embodiment the window structure has dimensions of 4,000 mm×3,000 mm with plural frame areas as shown in FIG. 4. This window structure comprises a glass pane with a softening point above 875° C. and a thickness of 6 mm, which was made from glass that was manufactured by the float process and chemically pre-stressed, and a counter glass pane made from 4-mm thick Ca—Na glass, which is spaced from the chemically pre-stressed glass pane with a steel spacer of 12 mm, so as to form a glass insulating window structure. The largest glass pane dimension amounted to 1,400 mm×2,800 mm. The glass insertion depth amounted to 15 mm. The stop section and screwed in glass molding were selected.

Fire testing took place with this window structure according to the DIN EN 1363-1.

The service life of this window structure amounted to more than 120 min, so that this fire-resistant window had a fire resistance class of E 120.

The window structure, like that of example 1, can be embodied as a pure glass separating wall or in combination with a door.

The purpose of the installation of insulating glass laminates or combination structures in building interiors is usually reduction of sound wave transmission from one room to another. When used in the outer parts of a building the insulating glass laminates or combination structures can also reduce heat losses to the environment.

FIG. 6 shows the above-mentioned insulating glass laminate or combination structure, which comprises at least two glass panes, in which the first pane 2 comprises a monolithic glass pane or a combination as described in examples 1 and 2 according to the invention and the other glass pane is a counter pane 7.

An aluminum or steel spacer 8, which is filled with a drying agent, is arranged in the intervening space 7a between the glass panes in the edge region 2a. A primary seal 9 and a secondary seal 10, which comprise known sealing material, seal the laminate window structure.

Melt vents are optionally arranged in the spacer 8.

An unstressed Ca/Na (soda lime) glass pane, an ESG glass pane, or a VSG glass pane comprising a Ca—Na or an ESG glass pane, can be used as the counter pane 7. The counter pane 7 can be optionally colored, printed and/or painted.

According to a fourth embodiment the glass pane can be made from glass with a softening point above 875° C., which is manufactured by the float process and chemically pre-stressed, which is provided with a reflective coating, a so-called low-E coating, and a sun-protective coating. The purpose for using these layers is, according to the particular application, to save energy by reducing heat loss through the window, to reduce the action of the suns rays through the window, and/or to reduce the IR or heat radiation passing through the window (EW class window).

The layers are applied according to know sputtering, pyrolysis or dipping processes.

Properties, such as sun and heat protection, can be combined with high resistance to mechanical stresses and splinter-binding action by combining the coated glass pane 2 and the counter glass pane 7 described in example 3.

While the invention has been illustrated and described as embodied in a fire-resistant window, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A fire-resistant window of fire resistance class E according to DIN EN 357, said fire-resistant window comprising a window frame system (1, 6) and at least one thermally or chemically pre-stressed monolithic fire-resistant glass pane (2) mounted in said window frame system (1, 6);
wherein said at least one thermally or chemically pre-stressed monolithic fire-resistant glass pane (2) comprises a high-temperature-melting aluminosilicate glass with a softening point above 875° C., such that log η=7.6 at said softening point and η is a viscosity of the aluminosilicate glass at said softening point; and
wherein said at least one thermally or chemically pre-stressed monolithic fire-resistant glass pane (2) has a bending strength of over 100 N/mm² and is substantially impermeable to ultraviolet radiation.

2. The fire-resistant window as defined in claim 1, wherein the high-temperature-melting aluminosilicate glass has an E modulus over 75,000 N/mm².

3. The fire-resistant window as defined in claim 1, wherein said at least one thermally or chemically fire-resistant glass pane (2) is thermally pre-stressed and said bending strength thereof is over 120 N/mm².

4. The fire-resistant window as defined in claim 1, wherein said at least one thermally or chemically fire-resistant glass pane (2) is chemically pre-stressed and said bending strength thereof is over 500 N/mm².

5. The fire-resistant window as defined in claim 1, wherein said at least one thermally or chemically fire-resistant glass pane (2) has a transmission in a range of from 90 to 92% for visible light.

6. The fire-resistant window as defined in claim 1, wherein said at least one thermally or chemically fire-resistant glass pane (2) has a thickness of 2 to 20 mm.

7. The fire-resistant window as defined in claim 1, wherein said at least one thermally or chemically fire-resistant glass pane (2) has a coating.

8. The fire-resistant window as defined in claim 1, wherein said frame system (1, 6) is made from wood, steel, aluminum, or combinations thereof.

9. The fire-resistant window as defined in claim 1, further comprising additional glass panes besides said at least one thermally or chemically fire-resistant glass pane (2), and wherein said additional glass panes are mounted with said at least one fire-resistant glass pane (2) in said frame system (1, 6) and said frame system (1, 6) comprises wood, steel, aluminum, or combinations thereof.

10. The fire-resistant window as defined in claim 1, wherein an edge region of said at least one thermally or chemically fire-resistant glass pane (2) inserted in said frame system (1, 6) is covered by at least one glass molding (3).

11. The fire-resistant window as defined in claim 1, further comprising a counter pane (7) held in said frame system (1, 6) spaced from said at least one thermally or chemically fire-resistant window (2) so as to form an insulated window structure.

12. The fire-resistant window as defined in claim 1, wherein said at least one thermally or chemically fire-resistant glass pane (2) comprises a float glass.
